(19) United States
(12) Patent Application Publication
(10) Pub. No.: US 2015/0121083 A1
(43) Pub. Date: Apr. 30, 2015

(54) METHOD, DEVICE, AND TERMINAL FOR INSTALLING BROWSER PLUG-IN

(71) Applicant: TENCENT TECHNOLOGY (SHENZHEN) COMPANY LIMITED, Shenzhen (CN)

(72) Inventor: Baohua Zhang, Shenzhen (CN)

(73) Assignee: TENCENT TECHNOLOGY (SHENZHEN) COMPANY LIMITED

(21) Appl. No.: 14/583,133

(22) Filed: Dec. 25, 2014

Related U.S. Application Data
(63) Continuation of application No. PCT/CN2013/078056, filed on Jun. 26, 2013.

(30) Foreign Application Priority Data
Jun. 26, 2012 (CN) 201210214155.6

(51) Int. Cl. H04L 9/32; G06F 9/445

(52) U.S. Cl. CPC H04L 9/3247; G06F 8/61
USPC 713/176

(57) ABSTRACT

The present invention relates to mobile terminals and provides a method, device, and terminal for installing a browser plug-in. The method includes: receiving an instruction of installing a browser plug-in which is applied in a designated browser; and judging whether the browser plug-in is legal according to digital signature information of the browser plug-in and browser information of the designated browser, if yes, installing the browser plug-in, otherwise, rejecting the installation of the browser plug-in. At the beginning of the installation of the browser plug-in, the browser plug-in is verified according to the digital signature information of the browser plug-in and the browser information of the designated browser corresponding to the browser plug-in, thus, the legality and traceability of the browser plug-in can be determined to prevent the harmful browser plug-in from calling API of the mobile terminal at random and further to improve the safety of the mobile terminal.

### CROSS-REFERENCE TO RELATED APPLICATIONS

This present application is a Continuation application of PCT application No. PCT/CN2013/078056, filed on Jun. 26, 2013, which claims the benefit of Chinese Patent Application No. 201210214155.6, entitled “Method and Device for Installing Browser Plug-in”, filed on Jun. 26, 2012, the contents of which are hereby incorporated by reference.

### FIELD OF THE INVENTION

The present invention relates to computer technologies, and more particularly, to a method, device, and terminal for installing a browser plug-in.

### BACKGROUND OF THE INVENTION

With the rapid development of the mobile terminal technology, a user may visit the network via a browser installed on a mobile terminal. The browser of a mobile terminal supports the expansion of a browser plug-in. The browser plug-in can call the corresponding application programming interface (API) of the mobile terminal at runtime to obtain corresponding files or information. Since the browser plug-in is a kind of application program, and the process of installing the browser plug-in is with the same as the process of installing an application on the mobile terminal, that is, the process of installing the browser plug-in is not limited to the source thereof.

At present, in the process of installing the browser plug-in, the source and the legality of the browser plug-in are not controlled. In this way, after the browser plug-in is installed on the mobile terminal, the browser plug-in can visit the API of the mobile terminal at random and cannot be controlled when being executed. If the browser plug-in is a harmful browser plug-in, arbitrary call to the API of the mobile terminal made by the browser plug-in cannot be prevented, and the benefit and privacy of users of the mobile terminal cannot be protected.

### SUMMARY OF THE INVENTION

In order to overcome the shortcomings of the present technology, an object of the present invention is to provide a method, device, and terminal for installing a browser plug-in. The technical solution is detailed as follows.

In a first aspect, a method for installing a browser plug-in is provided, including:

receiving an instruction of installing a browser plug-in which is applied in a designated browser; and

judging whether the browser plug-in is legal according to digital signature information of the browser plug-in and browser information of the designated browser, if yes, installing the browser plug-in, otherwise, rejecting the installation of the browser plug-in.

Furthermore, judging whether the browser plug-in is legal according to digital signature information of the browser plug-in and browser information of the designated browser includes:

verifying the digital signature information of the browser plug-in according to the browser information; if the browser information matches the digital signature information, the browser plug-in is legal, otherwise, the browser plug-in is illegal.

Furthermore, before judging whether the browser plug-in is legal according to digital signature information of the browser plug-in and browser information of the designated browser, the method includes:

displaying an API declared by the browser plug-in; and

continuing or stopping the installation of the browser plug-in according to a received operation instruction.

Furthermore, displaying an API declared by the browser plug-in includes:

displaying the API declared by the browser plug-in and displaying a sensitivity level of the API.

Furthermore, the digital signature information is carried by the browser plug-in and is obtained by digitally signing the browser plug-in by a server of the designated browser.

In a second aspect, a method for processing a browser plug-in is provided, including:

receiving a browser plug-in; and

processing the browser plug-in according to an API of a designated browser called by the browser plug-in.

Furthermore, processing the browser plug-in according to an API of a designated browser called by the browser plug-in includes:

judging whether the API of the designated browser called by the browser plug-in matches an API declared by the browser plug-in;

if yes, digitally signing the browser plug-in and packaging and sending obtained digital signature information to the browser plug-in;

otherwise, stopping processing the browser plug-in.

In a third aspect, a device for installing a plug-in is provided, including:

a first receiving module, configured to receive an instruction of installing a browser plug-in which is applied in a designated browser;

a judging module, configured to judge whether the browser plug-in is legal according to digital signature information of the browser plug-in and browser information of the designated browser;

an installing module, configured to install the browser plug-in when the judging module determines that the browser plug-in is legal; and

the installing module being further configured to reject the installation of the browser plug-in when the judging module determines that the browser plug-in is illegal.

Furthermore, the judging module is configured to verify the digital signature information of the browser plug-in according to the browser information; if the browser information matches the digital signature information, the browser plug-in is legal, otherwise, the browser plug-in is illegal.

Furthermore, the device further includes a displaying module configured to display an API declared by the browser plug-in; and correspondingly the installing module is configured to continue or stop the installation of the browser plug-in according to a received operation instruction.

Furthermore, the display module is configured to display an API declared by the browser plug-in and a sensitivity level of the API.

Furthermore, the digital signature information is carried by the browser plug-in and is obtained by digitally signing the browser plug-in by a server of the designated browser.

In a fourth aspect, a device for processing a browser plug-in is provided, including:

a second receiving module, configured to receive a browser plug-in; and

a processing module, configured to process the browser plug-in according to an API of the designated browser called by the browser plug-in.

Furthermore, the processing module includes:

a judging unit, configured to judge whether the API of the designated browser called by the browser plug-in matches an API declared by the browser plug-in;

a processing unit, configured to digitally sign the browser plug-in when the API of the designated browser called by the browser plug-in matches the API of the browser plug-in, and package and send obtained digital signature information to the browser plug-in; and

the processing unit being further configured to stop processing the browser plug-in when the API of the designated browser called by the browser plug-in does not match the API of the browser plug-in.

The technical solution of the present invention has the following advantages:

with the technical solution provided in the present invention, at the beginning of the installation of the browser plug-in, the browser plug-in is verified according to the digital signature information of the browser plug-in and the browser information of the designated browser corresponding to the browser plug-in, thus, the legality and traceability of the browser plug-in can be determined to prevent the harmful browser plug-in from calling an API of the mobile terminal at random and further to improve the safety of the mobile terminal.

### BRIEF DESCRIPTION OF THE DRAWINGS

To clearly explain the technical solutions of the embodiments of the present invention, drawings that are required by the embodiments are briefly introduced. Apparently, the drawings described below are only some embodiments of the present invention. For those skilled in the art, other drawings according to these drawings can be obtained without creative efforts.

FIG. 1 is a flowchart of a method for installing a browser plug-in in accordance with an embodiment of the present invention;

FIG. 2 is a flowchart of a method for installing a browser plug-in in accordance with an embodiment of the present invention;

FIG. 3 is a flowchart of a method for processing a browser plug-in in accordance with an embodiment of the present invention;

FIG. 4 is a schematic view of a device for installing a browser plug-in in accordance with an embodiment of the present invention;

FIG. 5 is a schematic view of a device for processing a browser plug-in in accordance with an embodiment of the present invention; and

FIG. 6 is a schematic view of a terminal in accordance with an embodiment of the present invention.

### DETAILED DESCRIPTION OF THE INVENTION

In order to make the purpose, technical solution, and advantages of the present invention become more clearer, the embodiments of the present invention will be described in detail herein below with reference to the accompanying drawings.

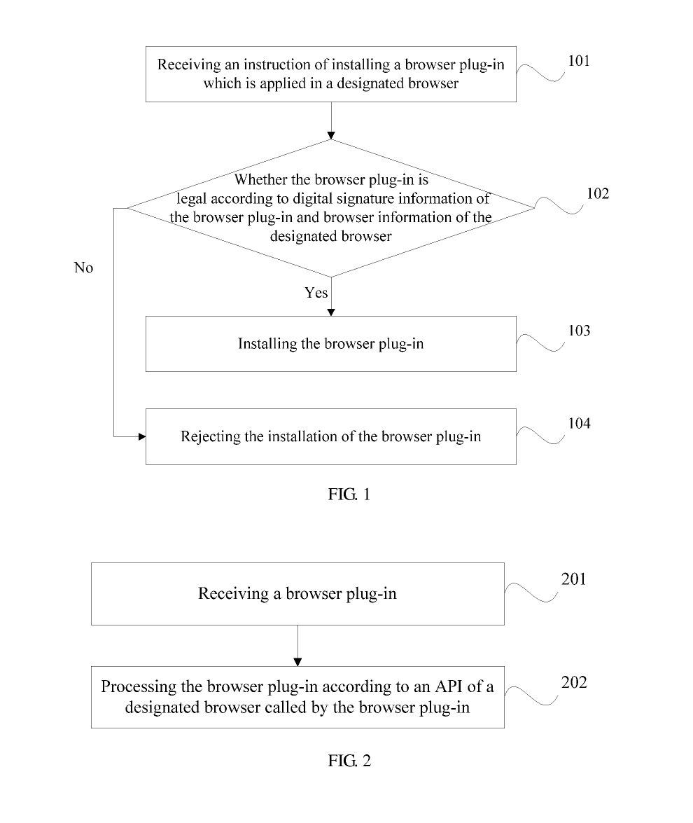

FIG. 1 is a flowchart of a method for installing a browser plug-in in accordance with an embodiment of the present invention. Based on that the subject for performing the method is a mobile terminal, as shown in FIG. 1, the method includes following steps:

step 101, receiving an instruction of installing a browser plug-in which is applied in a designated browser;

step 102, judging whether the browser plug-in is legal according to digital signature information of the browser plug-in and browser information of the designated browser; if yes, performing step 103; otherwise, performing step 104;

step 103, installing the browser plug-in; and

step 104, rejecting the installation of the browser plug-in.

Alternatively, the step of judging whether the browser plug-in is legal according to digital signature information of the browser plug-in and browser information of the designated browser includes but not limited to:

verifying the digital signature information of the browser plug-in according to the browser information; if the browser information matches the digital signature information, the browser plug-in is legal; otherwise, the browser plug-in is illegal.

Alternatively, before the step of judging whether the browser plug-in is legal according to digital signature information of the browser plug-in and browser information of the designated browser, following steps are included:

displaying an API declared by the browser plug-in; and

continuing or stopping the installation of the browser plug-in according to a received operation instruction.

Alternatively, the step of displaying an API declared by the browser plug-in includes but not limited to:

displaying the API declared by the browser plug-in and displaying a sensitivity level of the API.

Alternatively, the digital signature information is carried by the browser plug-in and is obtained by digitally signing the browser plug-in by a server of the designated browser.

The method provided in the present invention includes steps of receiving an instruction of installing a browser plug-in which is applied in a designated browser, judging whether the browser plug-in is legal according to the digital signature information of the browser plug-in and browser information of the designated browser, if yes, installing the browser plug-in, otherwise, rejecting the installation of the browser plug-in. With the technical solution of the present invention, at the beginning of the installation of the browser plug-in, the browser plug-in is verified according to the digital signature information of the browser plug-in and the browser information of the designated browser corresponding to the browser plug-in, thus, the legality and traceability of the browser plug-in can be determined to prevent the harmful browser plug-in from calling an API of the mobile terminal at random and further to improve the safety of the mobile terminal.

FIG. 2 is a flowchart of a method for processing a browser plug-in in accordance with an embodiment of the present invention. Based on that the subject for performing the method is a server in the embodiment, as shown in FIG. 2, the method includes following steps:

step 201, receiving a browser plug-in; and

step 202, processing the browser plug-in according to an API of a designated browser called by the browser plug-in.

Alternatively, the step of processing the browser plug-in according to an API of a designated browser called by the browser plug-in includes but not limited to:

judging whether the API of the designated browser called by the browser plug-in matches an API declared by the browser plug-in;

if yes, digitally signing the browser plug-in and packaging and sending obtained digital signature information to the browser plug-in;

if not, stopping processing the browser plug-in.

The method provided in the embodiment includes the step of judging whether the browser plug-in has the potential threat by judging whether the API declared by the received browser plug-in matches the API which is actually called. This determines the illegality and traceability of the browser plug-in, prevents the harmful browser plug-in from calling the API of a mobile terminal at random and further improves the safety of the mobile terminal.

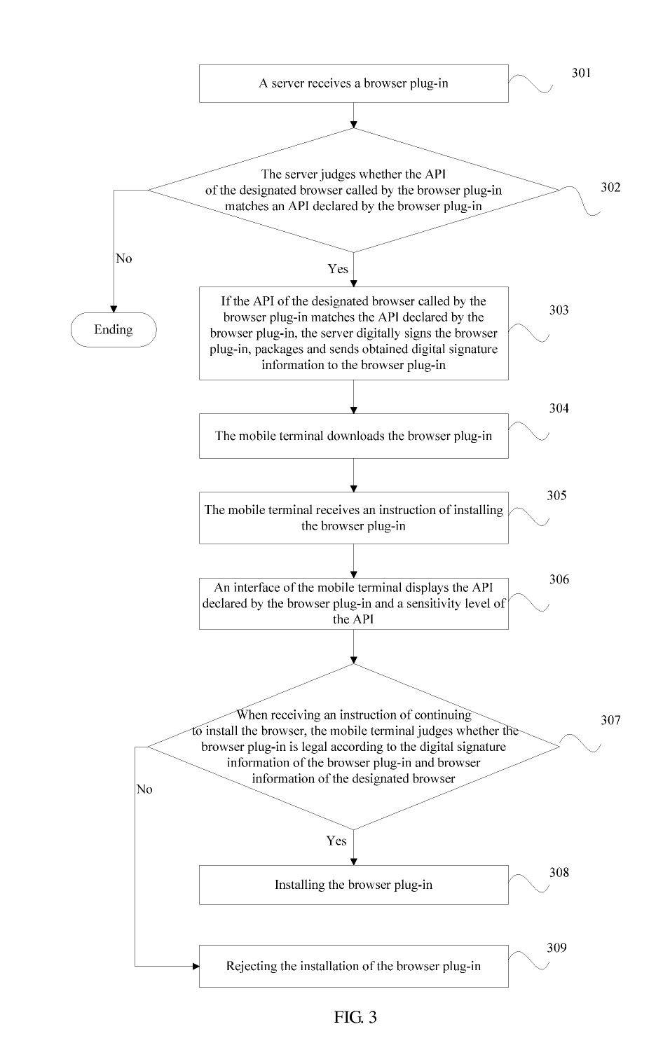

FIG. 3 is a flowchart of a method for installing a browser plug-in in accordance with an embodiment of the present invention. Based on that the browser plug-in is processed by a mobile terminal and a browser, as shown in FIG. 3, the method includes steps as follows.

Step 301, a server receives a browser plug-in.

The browser plug-in in the embodiment may refer to a plug-in which is developed to be installed and executed in the browser. The browser plug-in may include a variety of functions which are not limited herein, and the working process of the browser plug-in includes: during execution of a designated browser, calling an API of the mobile terminal designated by the browser plug-in and directly visiting the API of the mobile terminal to obtain corresponding files via the API. The API is some pre-defined functions for providing the capability allowing the application and the developer to visit a group of routines based on certain software or hardware. When the application or the plug-in calls a certain API, the mobile terminal visits the corresponding API, for example, when the browser needs to use an address book of the mobile terminal, the browser sends an instruction of calling an API of the address book to the mobile terminal, the mobile terminal receives the calling instruction and calls the API of the address book, thus, the browser visits the API of the address book to obtain corresponding files of the address book.

In the step, a developer or a user of the mobile terminal uploads the browser plug-in to a server of the designated browser to allow the server to receive the browser plug-in. It is noted that what is unloaded can be a compressed package of the browser plug-in or be exact the browser plug-in, which is not limited herein.

Step 302, the server judges whether the API of the designated browser called by the browser plug-in matches an API declared by the browser plug-in;

if yes, performing step 303;

if not, ending.

In the embodiment, each browser plug-in includes the declaration of the plug-in made by a developer. The declaration includes a name of the API called by the browser plug-in. The declaration can be formed as a list, for example, if the declaration of a browser plug-in A includes API1, API2, and API3, it can be understood that the browser plug-in A needs to call the API1, API2, and API3 at runtime.

Step 303, if the API of the designated browser called by the browser plug-in matches the API declared by the browser plug-in, the server digitally signs the browser plug-in, packages and sends obtained digital signature information to the browser plug-in.

In step 303, there are two ways of digitally signing the browser plug-in based on the encrypting manner: in a first way, a symmetric key encryption method is used, that is, both the data receiving side and data sending side need to use the same/symmetric key to encrypt and decrypt the plain text, in this way, the server uses the key thereof to digitally sign the browser plug-in, and packages and sends the obtained digital signature information to the browser plug-in; in a second way, an asymmetric key encryption method is used, that is, the server and the client side having the designated browser respectively have the corresponding public key and private key, in this way, the server uses the private key to digitally sign the browser plug-in, and the client side having the designated browser uses the corresponding public key to verify the browser plug-in when the browser plug-in is installed on the designated browser, thereby determining the safety of the browser plug-in.

The process that the server digitally signs the browser plug-in is detailed as follows: a Hash function is used to generate a message abstract from the message text of the browser plug-in, the server thereafter uses a private key corresponding to the public key thereof to encrypt the message abstract, thereby finishing the process of digitally signs the browser plug-in. The encrypted message abstract is namely the digital signature information of the browser plug-in. The above steps 301-303 show the process that the server verifies and digitally signs the browser plug-in. If the server digitally signs the browser plug-in, it indicates that the server approves the browser plug-in, which provides a basis for the mobile terminal to verify the legality of the browser plug-in.

Step 304, the mobile terminal downloads the browser plug-in.

It is noted that, after the server digitally signs the browser plug-in, the server can save the browser plug-in carrying the digital signature information and allow users to download the browser plug-in. The mobile terminal can download the browser plug-in either from the server or from the network, which is not limited herein.

Step 305, the mobile terminal receives an instruction of installing the browser plug-in.

When a user of the mobile terminal needs to install the browser plug-in, the user can triggers the instruction of installing the browser plug-in through a keyboard or a screen sliding gesture. When the instruction of installing the browser plug-in is received by the mobile terminal, the installation of the browser plug-in begins.

Step 306, an interface of the mobile terminal displays the API declared by the browser plug-in and a sensitivity level of the API.

The sensitivity level of the API can be set by a developer according to the specific function of the API during the development of the browser plug-in. The sensitivity level of the browser plug-in includes two levels which, for example, can be respectively indicated by the number “1” and “0”. The number “1” may indicate the browser plug-in is a sensitive one and the number “0” may indicate that the browser plug-in is an insensitive one. When being displayed on the interface of the mobile terminal, according to the presetting from the developer, the called API and the sensitivity level thereof are displayed as “API+ the sensitivity level” such as “API of the address book+“1”” and “API of the system file+“0”” which respectively indicate that the API of the address book is a sensitivity one and the API of the system file is a insensitive one. The sensitivity level of the API can include more than two levels according to the setting from the developer, which is not limited herein.

Since the sensitivity level of the API is simultaneously displayed together with the API, a user of the mobile terminal can get a preliminary understanding of the API called by the browser plug-in; when the API called by the browser plug-in is a sensitive one, the user can determine to continue or stop the installation of the browser plug-in.

Step 307, when receiving an instruction of continuing to install the browser, the mobile terminal judges whether the browser plug-in is legal according to the digital signature information of the browser plug-in and browser information of the designated browser;

if yes, performing step 308;

if not, performing step 309.

Correspondingly, operation instructions are also displayed on the interface of the mobile terminal for prompting the user to continue or stop the installation of the browser plug-in, for example, two operation instructions “install” and “cancel” are respectively displayed on the bottom left and the right left of the displaying interface, and the two operations corresponding thereto are respectively controlled by the left function key and the right function key on the mobile terminal. Thus, the user of the mobile terminal can determine whether to install the browser plug-in or not according to the declared API and the sensitivity level thereof displayed on the interface. When the mobile terminal receives the instruction of continuing to install the browser plug-in, the installation of the browser plug-in is continued.

In the embodiment, the browser information is the public key of the designated browser which corresponds to the private key that the server uses to digitally sign the browser plug-in. In this way, the mobile terminal verifies the digital signature information of the browser plug-in according to the public key of the designated browser. When the browser information matches the digital signature information, it indicates that the browser plug-in is legal; otherwise, it indicates that the browser plug-in is illegal. The process of verifying the browser plug-in is known to one having ordinary skill in the art, which is not described herein.

Step 308, installing the browser plug-in.

The process of installing the browser plug-in in the mobile terminal is similar to that of installing an application, which is not described herein.

Step 309, rejecting the installation of the browser plug-in.

The method provided in the present invention includes steps of: receiving an instruction of installing a browser plug-in which is applied in a designated browser; and judging whether the browser plug-in is legal according to digital signature information of the browser plug-in and browser information of the designated browser, if yes, installing the browser plug-in, otherwise, rejecting the installation of the browser plug-in. With the technical solution of the present invention, at the beginning of the installation of the browser plug-in, the browser plug-in is verified according to the digital signature information of the browser plug-in and the browser information of the designated browser corresponding to the browser plug-in, thus, the legality and traceability of the browser plug-in can be determined to prevent the harmful browser plug-in from calling an API of the mobile terminal at random and further to improve the safety of the mobile terminal.

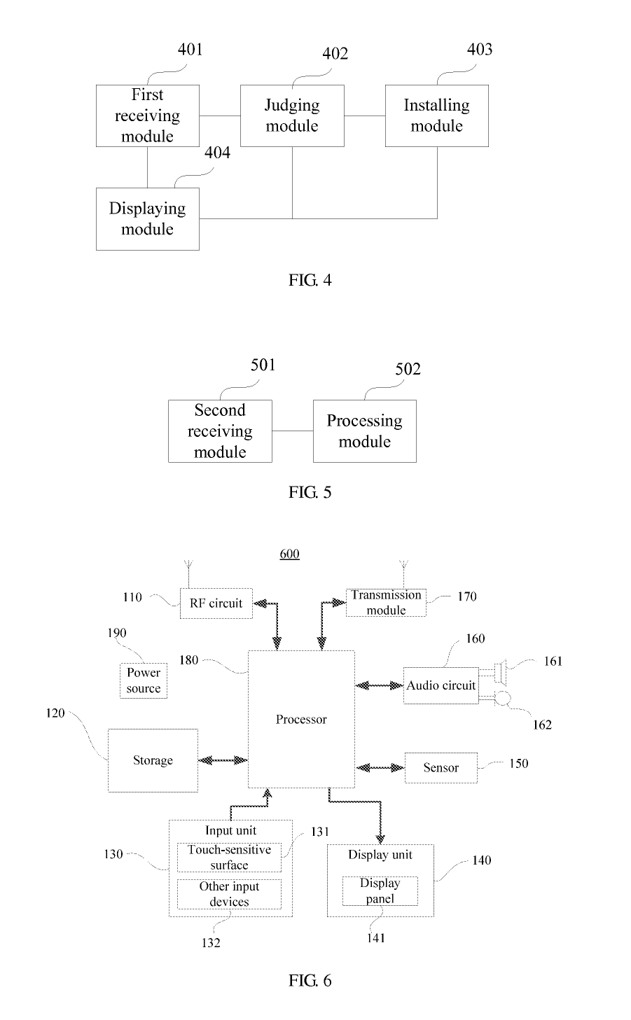

FIG. 4 is a schematic view of a device for installing a browser in accordance with an embodiment of the present invention. The device can be located in a terminal device like a mobile terminal or a fixed terminal. The mobile terminal can be a smart phone, a notebook computer, or other mobile apparatus. The fixed terminal can be a personal computer. As shown in FIG. 4, the device includes:

a first receiving module 401, configured to receive an instruction of installing a browser plug-in which is applied in a designated browser;

a judging module 402, configured to judge whether the browser plug-in is legal or not according to digital signature information of the browser plug-in and browser information of the designated browser;

an installing module 403, configured to install the browser plug-in when the judging module 402 determines that the browser plug-in is legal;

the installing module 403 is further configured to reject the installation of the browser plug-in when the judging module 402 determines that the browser plug-in is illegal.

Alternatively, the judging module 402 is configured to verify the digital signature information of the browser plug-in according to the browser information; when the browser information matches the digital signature information, the browser plug-in is legal; otherwise, the browser plug-in is illegal.

Alternatively, the device further includes:

a displaying module 404 configured to display an API declared by the browser plug-in;

correspondingly, the installing module 403 is configured to continue or stop the installation of the browser plug-in according to a received operation instruction.

Alternatively, the displaying module 404 is configured to display the API declared by the browser plug-in and a sensitivity level of the API.

Alternatively, the digital signature information is carried by the browser plug-in and is obtained by digitally signing the browser plug-in by a server of the designated browser.

It is noted that, the process that the device provided in the above embodiment installs the browser plug-in is exemplarily illustrated based on the division of the above functional block. In practical application, according to actual requirements, the above functions can be implemented by different functional blocks, that is, the interior structure of the device can be divided into different functional blocks to implement all or at least some of the above functions. In addition, the method and device for installing a browser plug-in provided in the above embodiments belong to the same idea, and the process of implementing the device is similar to that of implementing the device, which will not be described herein.

The device provided in the embodiment receives an instruction of installing a browser plug-in which is applied in a designated browser, judges whether the browser plug-in is legal according to digital signature information of the browser plug-in and browser information of the designated browser; if yes, the device installs the browser plug-in; otherwise, the device rejects the installation of the browser plug-in. With the technical solution of the present invention, at the beginning of the installation of the browser plug-in, the browser plug-in is verified according to the digital signature information of the browser plug-in and the browser information of the designated browser corresponding thereto, thus, the legality and traceability of the browser plug-in can be determined to prevent the harmful browser plug-in from calling an API of the mobile terminal at random and further to improve the safety of the mobile terminal.

FIG. 5 shows a schematic view of a device for processing a browser plug-in in accordance with an embodiment of the present invention. The device is located in a server of a designated browser, as shown in FIG. 5, the device includes:

a second receiving module 501, configured to receive a browser plug-in; and

a processing module 502, configured to process the browser plug-in according to an API of the designated browser called by the browser plug-in.

Alternatively, the processing module 502 includes:

a judging unit, configured to judge whether the API of the designated browser called by the browser plug-in matches an API declared by the browser plug-in;

a processing unit, configured to digitally sign the browser plug-in when the API of the designated browser called by the browser plug-in matches the API of the browser plug-in, and package and send obtained digital signature information to the browser plug-in;

the processing unit is further configured to stop processing the browser plug-in when the API of the designated browser called by the browser plug-in does not match the API of the browser plug-in.

The device provided in the embodiment judges whether the browser plug-in has the potential threat by judging whether the API declared by the received browser plug-in matches the API which is actually called, thereby determining the legality and traceability of the browser plug-in, preventing the harmful browser plug-in from calling the API of the mobile terminal at random, and further improving the safety of the mobile terminal.

FIG. 6 is a schematic view of a terminal in accordance with an embodiment of the present invention, which can be used to perform the method for installing a browser plug-in provided in the above embodiment.

The terminal 600 includes components such as a Radio Frequency (RF) circuit 110, a storage 120, an input unit 130, a display unit 140, a sensor 150, an audio circuit 160, a transmission module 170, a processor 180, and a power source 190. One having ordinary skill in the art will appreciate that the structure of the terminal shown in FIG. 6 is not intended to limit the terminal, and the terminal can include more or less components, or some of the above components can be combined, or the arrangement of the components can be different.

The RF circuit 110 can be configured to receive and send signals during message receiving and sending processes or during calls, and particularly, to receive downlink messages from a base station and send the messages to the processor 180 for processing, and to send uplink data from the terminal to the base station. Generally, the RF circuit includes but not limited to an antenna, at least one amplifier, a tuner, a coupler, a lower noise amplifier (LNA), and a duplexer. Furthermore, the RF circuit 110 can communicate with other devices via wireless communication and networks. The wireless communication can utilize any communication standard or protocol, including but not limited to Global System of Mobile (GSM) communication, General Packet Radio Service (GPRS), Code Division Multiple Access (CDMA), Long Term Evolution (LTE), E-mail, Short Messaging Service (SMS).

The storage 120 can be configured to store software programs and modules, for example, software programs and modules corresponding to the device for installing a browser plug-in of the above embodiments, and the processor 180 performs various kinds of functions of the terminal and data processing, for example, realizes the installation of a browser plug-in, by running the software programs and modules stored in the storage 120. The storage 120 can mainly include a program storage area and a data storage area; the program storage area can store the operating system, at least one application required for functions (such as a sound playing function, an image playing function), etc.; the data storage area can store the data created according to the usage of the terminal (such as audio data and a phone book), etc. In addition, the storage 120 can further include a high-speed random access storage and a non-volatile storage such as at least one disk storage, flash storage, or other volatile solid state storages. Correspondingly, the storage 120 can further include a storage controller to provide access to the storage 120 from the processor 180 and the input unit 130.

The input unit 130 can be configured to receive input numbers or string information and generate key signal inputs associated with user settings and function controls of the terminal 600 from a keyboard, a mouse, an operation rod, a track pad, or a track ball, etc. In detail, the input unit 130 can include a touch sensitive surface 131 and other input devices 132. The touch sensitive surface 131, also known as a touch screen or a touch pad, can collect user's touch operations on the touch sensitive surface 131 or adjacent to the touch sensitive surface 131 (such as the operations on the touch sensitive surface 131 or adjacent to the touch sensitive surface 131 from the user by using any suitable object or accessory such as a finger or a touch pen) and drive the corresponding connection device according to preset formulas. Alternatively, the touch sensitive surface 131 can include a touch detecting device and a touch controller. The touch detecting device detects the orientation of the touch from the user, detects the signal generated from the touch, and transmits the signal to the touch controller; the touch controller receives touch information from the touch detecting device, converts the touch information to contact coordinates, transmits the contact coordinates to the processor 180, and executes the command received from the processor 180. Furthermore, the touch sensitive surface 131 can be a resistive type, a capacitive type, a RF type, and a surface acoustic wave type of touch panel. Except the touch sensitive surface 131, the input unit 130 can further include other input devices 132. Specifically, other input devices 132 include but not limited to one or more of a physical keyboard, a function button (such as a volume control button and a switch button), a trackball, a mouse, an operation rod.

The display unit 140 can be configured to display information input by a user or information provided to a user and various kinds of graphic user interfaces. The graphic user interfaces are composed of graphics, texts, icons, videos, and any combination of these elements. The display unit 140 can include a display panel 141. Alternatively, the display panel 141 can be configured by using a liquid crystal display (LCD) or an organic light-emitting diode (OLED) display. Furthermore, the touch sensitive surface 131 can cover the display panel 141; after detecting the touch operation on the touch sensitive surface 131 or adjacent to the touch sensitive surface 131, the touch sensitive surface 131 transmits the touch operation to the processor 180 for determining the type of the touch event, and the processor 180 then provides the corresponding visual output on the display panel 141 according to the type of the touch event. Although in FIG. 6, the touch sensitive surface 131 and the display panel 141 are two separated elements for realizing the input and output functions of the mobiles phone, in some embodiments, the touch sensitive surface 131 and the display panel 141 can be integrally formed to realize the input and output functions of the terminal.

The terminal 600 can further include at least one kind of sensor 150, such as an optical sensor, a motion sensor, and other sensors. Specifically, the optical sensor can include an ambient light sensor and a proximity sensor; the ambient light sensor can adjust the brightness of the display panel 141 according to the darkness of the ambient light, and the proximity sensor can turn off the display panel 141 and/or the backlight when the terminal gets close to the user's ear. As a motion sensor, an accelerometer can detect a value of an acceleration in each direction (being generally three axis), detect the value and direction of the gravity when being still, and can be used in applications of identifying gestures of the terminal (such as a switch between the portrait orientation and landscape orientation, associated games, and a magnetometer gesture calibration) and in associated vibration-identified functions (such as a pedometer and knockings), etc.; the terminal can further be configured with other sensors such as a gyroscope, a barometer, a moisture meter, a thermometer, a RF sensor, which is not given in detail herein.

The audio circuit 160, the loudspeaker 161, and the microphone 162 can provide an audio interface between the user and the terminal. The audio circuit 160 can transmit electrical signals converted from the received audio data to the loudspeaker 161 to be output as voice signals by the loudspeaker 161; in addition, the microphone 162 converts collected voice signals to electrical signals which are received and converted to audio data by the audio circuit 160; the audio data is then output to the processor 180 for processing and is further transmitted to for example another terminal or to the storage 120 for further processing via the RF circuit 110.

The terminal 600 can assist a user in receiving and sending E-mails, browsing web pages, and accessing stream media via the transmission module 170 which provides wired or wireless access to the Internet for the user. Although FIG. 6 shows the transmission module 170, it can be understood that the transmission module is not the essential component of the terminal 600 and can be omitted according to requirements without departing from the spirit of the present invention.

The processor 180 is the control center of the terminal 600 which is capable of connecting each part of the terminal using various kinds of interfaces and circuitries and performing various kinds of functions of the terminal and processing data by running or executing the software programs and/or modules stored in the storage 120 and calling the data stored in the storage 120, thereby realizing overall monitoring of the terminal. Alternatively, the processor 180 can include one or more processing units; preferably, the processor 180 integrates an application processor and a modulation and demodulation processor, the application processor mainly processes the operation system, user interfaces, and application programs, etc., and the modulation and demodulation processor mainly processes wireless communications. It can be understood that the modulation and demodulation processor cannot be integrated in the processor 180.

The terminal 600 can further include a power source 190 (such as a battery) for supplying power to each component; preferably, the power source can be logically connected to the processor 180 via a power management system, thereby managing the charging, discharging, and power consumption functions via the power management system. The poser source 190 can further include one or more direct current sources or alternate current sources, a recharging system, a failure detecting circuit of the power source, a power converter or inverter, a power state indicator, etc.

Although not shown, the terminal 600 can further include a camera and a Bluetooth module, etc., which is not given in detail herein. In a specific embodiment of the present invention, the display unit of the terminal is a display with a touch screen, and the terminal further includes the storage and one or more programs stored in the storage. On or more processors are configured to execute instructions stored in the one or more programs for performing the following operations:

receiving an instruction of installing a browser plug-in which is applied in a designated browser; and

judging whether the browser plug-in is legal according to digital signature information of the browser plug-in and browser information of the designated browser; if yes, installing the browser plug-in, otherwise, rejecting the installation of the browser plug-in.

Supposed that the above embodiment is a first possible embodiment, in a second possible embodiment provided based on the first possible embodiment, instructions for performing the following operation are stored in the storage of the terminal:

determining that the browser plug-in is legal when the browser information matches the digital signature information; otherwise, determining that the browser plug-in is illegal.

In a third possible embodiment provided based on the first possible embodiment, instructions for performing the following operation are further stored in the storage of the terminal:

displaying an API declared by the browser plug-in;

continuing or stopping the installation of the browser plug-in according to a received operation instruction.

In a fourth possible embodiment provided based on the first possible embodiment, instructions for performing the following operation are further stored in the storage of the terminal:

displaying the API declared by the browser plug-in and displaying a sensitivity level of the API.

In a fifth possible embodiment provided based on the first, second, third, or fourth possible embodiment, instructions for performing the following operation are further stored in the storage of the terminal:

digitally signing the browser plug-in by a server of the designated browser to obtain the digital signature information carried by the browser plug-in.

As mentioned above, the terminal provided in the embodiment can judge whether the browser plug-in has the potential threat by judging whether the API declared by the received browser plug-in and the API which is actually called, thereby determining the legality and traceability of the browser plug-in, preventing the harmful browser plug-in from calling the API of the mobile terminal at random, and further improving the safety of the mobile terminal.

The present invention further provides a computer-readable storage medium. The computer-readable storage medium can be a computer-readable storage medium contained in the storage of the above embodiment or an independent computer-readable storage medium which is not installed on the terminal. At least one or more programs are stored in the computer-readable medium which can be executed by one or more processors for performing a method for installing a browser plug-in; the method includes:

receiving an instruction of installing a browser plug-in which is configured to designate a browser; and

judging whether the browser plug-in is legal or not according to digital signature information of the browser plug-in and browser information of the designated browser; if yes, installing the browser plug-in, otherwise, rejecting the installation of the browser plug-in.

Supposed that the description mentioned above is the first possible embodiment, in a second possible embodiment provided based on the first possible embodiment, judging whether the browser plug-in is legal or not according to digital signature information of the browser plug-in and browser information of the designated browser includes:

verifying the digital signature information of the browser plug-in according to the browser information, if the browser information matches the digital signature information, the browser plug-in is legal; otherwise, the browser is illegal.

In a third possible embodiment provided based on the first possible embodiment, judging whether the browser plug-in is legal or not according to digital signature information of the browser plug-in and browser information of the designated browser includes:

displaying an API declared by the browser plug-in; and

continuing or stopping the installation of the browser plug-in according to a received operation instruction.

In a forth possible embodiment provided based on the third possible embodiment, displaying an API declared by the browser plug-in includes:

displaying the API declared by the browser plug-in and a sensitivity level of the API.

In a fifth possible embodiment provided based on the first, second, third or fourth possible embodiment, the digital signature information is carried by the browser plug-in and is obtained by digitally signing the browser plug-in by a server of the designated browser.

The computer-readable storage medium provided in the above embodiments can judge whether the browser plug-in has the potential threat by judging whether the API declared by the received browser plug-in and the API which is actually called, thereby determining the legality and traceability of the browser plug-in, preventing the harmful browser plug-in from calling the API of the mobile terminal at random, and further improving the safety of the mobile terminal.

The present invention provides a graphic user interface applied in a terminal which includes a touch screen display, a storage, one or more processors for executing one or more programs; the graphic user interface includes:

displaying an instruction of installing a browser plug-in which is applied in a designated browser on the touch screen display; and

judging whether the browser is legal or not according to digital signature information of the browser plug-in and browser information of the designated browser; if yes, installing the browser plug-in, otherwise, rejecting the installation of the browser plug-in.

The graphic user interface provided in the above embodiments can judge whether the browser plug-in has the potential threat by judging whether the API declared by the received browser plug-in and the API which is actually called, thereby determining the legality and traceability of the browser plug-in, preventing the harmful browser plug-in from calling the API of the mobile terminal at random, and further improving the safety of the mobile terminal.

It is noted that the process that the device for installing a browser plug-in installs the browser plug-in provided in the above embodiment is exemplarily illustrated based on the division of the above functional blocks. In practical application, the above functions can be implemented by different functional blocks according to requirements, that is, the interior structure of the device can be divided into different functional modules to perform all or some of the above functions. In addition, the device and method for installing a browser plug-in provided in the above embodiments belong to the same idea and the process of implementing the device is similar to that of implementing the device, which will not be described herein.

The serial number of the above embodiment is only for illustration and is not an indication of the merit of the embodiment.

It will be appreciated by those having ordinary skill in the art that all the steps or at least some steps of the above embodiments can be realized by hardware or by instructing hardware by procedures, and all the procedures can be stored in a computer readable storage medium, and the above storage medium can be a read-only memory, a disc or an optical disc, etc.

The foregoing descriptions are only preferred embodiments of the present invention and are not intended to limit the present invention. Any modification, equivalent replacement and improvement made under the spirit and principle of the present invention should be included in the protection scope thereof.

What is claimed is:

1. A method for installing a browser plug-in, comprising:
receiving an instruction of installing a browser plug-in which is applied in a designated browser; and
judging whether the browser plug-in is legal according to digital signature information of the browser plug-in and browser information of the designated browser, if yes, installing the browser plug-in, otherwise, rejecting the installation of the browser plug-in.

2. The method of claim 1, wherein judging whether the browser plug-in is legal according to digital signature information of the browser plug-in and browser information of the designated browser comprises:
verifying the digital signature information of the browser plug-in according to the browser information; if the browser information matches the digital signature information, the browser plug-in is legal, otherwise, the browser plug-in is illegal.

3. The method of claim 1, wherein before judging whether the browser plug-in is legal according to digital signature information of the browser plug-in and browser information of the designated browser, the method comprises:
displaying an API declared by the browser plug-in; and
continuing or stopping the installation of the browser plug-in according to a received operation instruction.

4. The method of claim 3, wherein displaying an API declared by the browser plug-in comprises:
displaying the API declared by the browser plug-in and displaying a sensitivity level of the API.

5. The method of claim 1, wherein the digital signature information is carried by the browser plug-in and is obtained by digitally signing the browser plug-in by a server of the designated browser.

6. The method of claim 2, wherein the digital signature information is carried by the browser plug-in and is obtained by digitally signing the browser plug-in by a server of the designated browser.

7. The method of claim 3, wherein the digital signature information is carried by the browser plug-in and is obtained by digitally signing the browser plug-in by a server of the designated browser.

8. A terminal, comprising a touch screen, one or more processors, a storage, and one or more programs being stored in the storage and being configured to be executed by the one or more processors, the one or more programs comprising instructions for performing following operations:
receiving an instruction of installing a browser plug-in which is applied in a designated browser; and
judging whether the browser plug-in is legal according to digital signature information of the browser plug-in and browser information of the designated browser, if yes, installing the browser plug-in, otherwise, rejecting the installation of the browser plug-in.

9. The terminal of claim 8, further comprising instructions for performing following operations:
verifying the digital signature information of the browser plug-in according to the browser information, if the browser information matches the digital signature information, the browser plug-in is legal, otherwise, the browser plug-in is illegal.

10. The terminal of claim 8, further comprising instructions for performing following operations:
displaying an API declared by the browser plug-in; and
continuing or stopping the installation of the browser plug-in according to a received operation instruction.

11. The terminal of claim 10, further comprising instructions for performing following operations:
displaying the API declared by the browser plug-in and displaying a sensitivity level of the API.

12. The terminal of claim 8, further comprising instructions for performing following operations:
carrying the digital signature information by the browser plug-in, and obtaining the digital signature information by digitally signing the browser plug-in by a server of the designated browser.

13. The terminal of claim 9, further comprising instructions for performing following operations:
carrying the digital signature information by the browser plug-in, and obtaining the digital signature information by digitally signing the browser plug-in by a server of the designated browser.

14. The terminal of claim 10, further comprising instructions for performing following operations:
carrying the digital signature information by the browser plug-in, and obtaining the digital signature information by digitally signing the browser plug-in by a server of the designated browser.

15. A computer-readable storage medium storing one or more programs which are executed by one or more processors to perform a method for installing a browser plug-in, the method comprising:
receiving an instruction of installing a browser plug-in which is applied in a designated browser; and
judging whether the browser plug-in is legal according to digital signature information of the browser plug-in and browser information of the designated browser, if yes, installing the browser plug-in, otherwise, rejecting the installation of the browser plug-in.

16. The computer-readable storage medium of claim 15, wherein judging whether the browser plug-in is legal according to digital signature information of the browser plug-in and browser information of the designated browser comprises:
verifying the digital signature information of the browser plug-in according to the browser information; if the browser information matches the digital signature information, the browser plug-in is legal, otherwise, the browser plug-in is illegal.

17. The computer-readable storage medium of claim 15, wherein before judging whether the browser plug-in is legal according to digital signature information of the browser plug-in and browser information of the designated browser, the method comprises:
displaying an API declared by the browser plug-in; and
continuing or stopping the installation of the browser plug-in according to a received operation instruction.

18. The computer-readable storage medium of claim 17, wherein displaying an API declared by the browser plug-in comprises:
displaying the API declared by the browser plug-in and displaying a sensitivity level of the API.

19. The computer-readable storage medium of claim 15, wherein the digital signature information is carried by the browser plug-in and is obtained by digitally signing the browser plug-in by a server of the designated browser.

20. The computer-readable storage medium of claim 16, wherein the digital signature information is carried by the browser plug-in and is obtained by digitally signing the browser plug-in by a server of the designated browser.
